(19) United States
(12) Patent Application Publication
(10) Pub. No.: US 2005/0281717 A1
(43) Pub. Date: Dec. 22, 2005

(54) Method for measuring the uniform filling of reactors with solid matter

(75) Inventors: Achim Fischer, Aschaffenburg (DE); Werner Burkhardt, Brachttal (DE); Jan-Olaf Barth, Frankfurt (DE); Christoph Weckbecker, Grundau (DE)

Correspondence Address: PILLSBURY WINTHROP SHAW PITTMAN, LLP, P.O. BOX 10500, MCLEAN, VA, 22102, US

(73) Assignee: Degussa AG, Dusseldorf (DE)

(21) Appl. No.: 11/138,428

(22) Filed: May 27, 2005

Related U.S. Application Data
(60) Provisional application No. 60/575,419, filed on Jun. 1, 2004.

(30) Foreign Application Priority Data
May 27, 2004 (DE) 10 2004 025 872.4

(51) Int. Cl. G05B 1/00

(52) U.S. Cl. 422/105; 422/110; 422/112

(57) ABSTRACT

The invention relates to a method for measuring the uniform filling of reactors or columns with solid matter and an apparatus for carrying out the method.

This application claims priority to U.S. Provisional Application No. 60/575,419, filed Jun. 1, 2004 and German Application No. 10 2004 025 872.4, filed May 27, 2004, both of which are hereby incorporated by reference in their entirety.

### FIELD OF THE INVENTION

The invention relates to a method for measuring the uniform filling of reactors or columns with solid matter and an apparatus for carrying out the method.

### BACKGROUND

In chemical reaction technology, the uniform filling of reactors with solid matter makes the apparatus more efficient. The solid matter may be, for example, tower packing or catalysts.

The solid matter may have different compositions and geometries. It may comprise spheres, solid or hollow cylinders or rings, as well as other geometries.

If the solid matter is used in multi-tube reactors or plate reactors for catalyzed conversions, for example, the reactors should be uniformly filled.

### SUMMARY

An aspect of the invention relates to a method for measuring the uniform filling of reactors with solid matter, the reactors being constructed in a manner that at least two separately conducted gas and liquid streams having the same composition flow through the reactors and the measurement is carried out in such a way that after the filling with solid matter (a) gas or liquid having the same mass flow and pressure in each case is introduced simultaneously at least two of the separately mounted gas or liquid inlets, (b) the flow resistance at each of the inlets is measured simultaneously and, (c) the values determined are registered centrally.

Another aspect of the invention relates to a method of measuring the uniform filling of reactors or columns with solid matter, comprising the steps of: (a) providing at least two reactors or columns filled with solid matter, wherein the reactors or columns have separately conducted gas or liquid streams having substantially the same composition flow through the reactors or columns; (b) introducing at least two separately mounted gas or liquid inlets into the reactors or columns, wherein the inlets are capable of measuring flow resistance of the gas or liquid streams in the reactors or columns; (c) simultaneously measuring the flow resistance at each of the inlets; and (d) recording the flow resistance at a central register.

Another aspect of the invention relates to apparatus for measuring the uniform filling of reactors or columns with solid matter, comprising: (a) at least two devices capable of measuring the constant metering of gas; (b) at least two devices capable of measuring the back pressure or gas flow in the reactors or columns filled with solid matter, wherein the devices of element (a) and the devices of element (b) are connected to one another; and (c) a central register capable of recording measurement values obtained from the devices.

### BRIEF DESCRIPTION OF THE DRAWINGS

FIG. 1 depicts an apparatus for the uniform metering of the gas flow through a plurality of parallel gas lines.

FIG. 2 depicts an apparatus for measuring the back pressure.

### DETAILED DESCRIPTION

An aspect of the invention relates to a method of measuring the uniform filling of reactors or columns with solid matter, comprising the steps of: (a) providing at least two reactors or columns filled with solid matter, wherein the reactors or columns have separately conducted gas or liquid streams having substantially the same composition flow through the reactors or columns; (b) introducing at least two separately mounted gas or liquid inlets into the reactors or columns, wherein the inlets are capable of measuring flow resistance of the gas or liquid streams in the reactors or columns; (c) simultaneously measuring the flow resistance at each of the inlets; and (d) recording the flow resistance at a central register.

The central register may be a central data storage device. Preferably, the reactors are multi-tube reactors and reactors having reaction and heat transport chambers separated from one another by thermal metal sheets. The columns may be, for example, absorption columns. Inert gases, air or mixtures thereof are generally used as the gases.

The piled solid matter presents a resistance to the gas flow by which the flow velocity is reduced and a back pressure is built up. The solid matter may contain tower packing, catalysts, or a combination thereof. Preferably, the solid matter contains catalysts.

A constant volume flow should be conducted through the piled solid matter. The volume flow of the gas should in general have a flow rate of about 250 to about 5000 l/h, the admission pressure of the gas should be in the range from about 1 bar to about 50 bar, in particular from about 1 to about 10 bar, while the temperature of the gas should generally be in the range from about 10 to about 50° C. Inert gases, air or mixtures thereof are preferred.

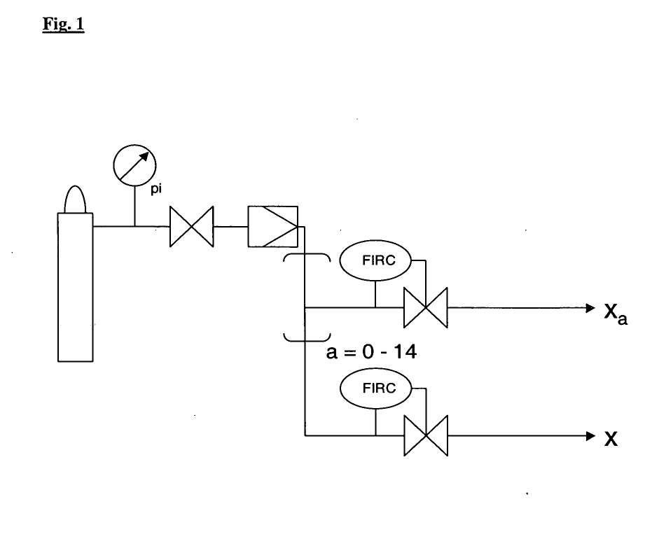

A device such as that shown in FIG. 1, which is constructed to correspond to the number of parallel gas lines, may be used for constant metering of the gases. The metering is considered to be constant when the flow rate of the gas fluctuates by less +/−2.5%; flow rates having a fluctuation of not more than +/−1% are preferred.

The back pressure may be measured in devices having up to 15 parallel gas lines; preferably, the device contains 10 or fewer parallel gas lines; more preferably, the device contains 5 or fewer parallel gas lines. If different measurement values are produced, the solid matter that is not uniform should be corrected.

The simultaneous measurement, possible according to the invention, of a plurality of gas streams makes possible a time-saving method for checking the filling of reactors. In accordance with this disclosure, simultaneous means at or about the same time. A variance of up to +/−5% is regarded as uniform.

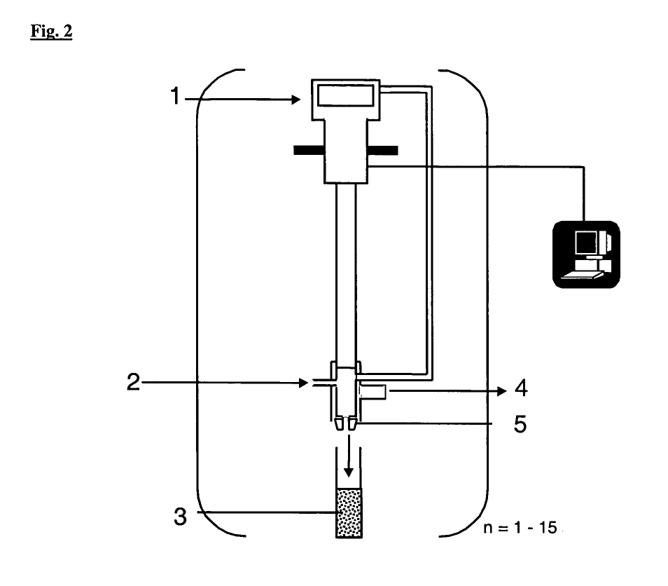

FIG. 1 illustrates an apparatus that may be used to uniformly meter the gas flow through a plurality of parallel gas lines. In FIG. 1, X represents the first gas line and Xₐ represents additional gas lines, up to 14 in number. FIG. 2 illustrates an apparatus that may be used to measure the back pressure of a gas stream. FIG. 2 contains a pressure transducer and optional data storage device (1); a gas inlet (2); piled solid matter (3); a gas outlet (4); and a seal (5).

The back pressure of the gas stream coming from the apparatus in FIG. 1 may be measured using the apparatus in FIG. 2. The back pressures generated may be measured using a commercially available pressure transducer, for example, those manufactured by Ashcroft Inc. The pressure transducer may be installed on the gas introduction device as shown in FIG. 2. The pressure range of the transducer should extend from 0 to 2500 mbar, in particular from 0 to 1000 mbar. The pressure data obtained are transmitted to an electronic storage device capable of recording up to 60000 pressure data items. This data storage device preferably is housed in one instrument with the pressure transducer.

The method is not limited to the measurement of back pressure as means for determining flow resistance. It is also possible to use other effects of the filling of reactors on the gas flow, such as the pressure drop in the piled solid matter or the flow velocity, as the basis for measurements. The gas flow may be measured as a volume flow or a mass flow.

The invention also relates to apparatus for measuring the uniform filling of reactors or columns with solid matter, comprising: (a) at least two devices capable of measuring the constant metering of gas; (b) at least two devices capable of measuring the back pressure or gas flow in the reactors or columns filled with solid matter, wherein the devices of element (a) and the devices of element (b) are connected to one another; and (c) a central register capable of recording measurement values obtained from the devices.

The reactors or columns with solid matter preferably have separately conducted gas or liquid streams having substantially the same composition flow through the reactors or columns. The other embodiments relating to the apparatus discussed above in connection to the method are equally applicable to the apparatus itself.

1. A method of measuring the uniform filling of reactors or columns with solid matter, comprising the steps of:
a. providing at least two reactors or columns filled with solid matter, wherein the reactors or columns have separately conducted gas or liquid streams having substantially the same composition flow through the reactors or columns,
b. introducing at least two separately mounted gas or liquid inlets into the reactors or columns, wherein the inlets are capable of measuring flow resistance of the gas or liquid streams in the reactors or columns;
c. simultaneously measuring the flow resistance at each of the inlets; and
d. recording the flow resistance at a central register.

2. The method of claim 1, wherein the central register is a central data storage device.

3. The method of claim 1, wherein the reactors are multi-tube reactors.

4. The method of claim 1, wherein the reactors are reaction and heat transport chambers.

5. The method of claim 4, wherein the reaction and heat transport chambers are separated from one another by thermal metal sheets.

6. The method of claim 1, wherein the columns are absorption columns.

7. The method of claim 1, wherein the gas is an inert gas.

8. The method of claim 1, wherein the solid matter is a composition comprising tower packing, catalysts, or a combination thereof.

9. The method of claim 1, wherein the reactors are multi-tube reactors and the solid matter is a composition comprising catalysts.

10. An apparatus for measuring the uniform filling of reactors or columns with solid matter, comprising:
a. at least two devices capable of measuring the constant metering of gas;
b. at least two devices capable of measuring the back pressure or gas flow in the reactors or columns filled with solid matter, wherein the devices of element (a) and the devices of element (b) are connected to one another; and
c. a central register capable of recording measurement values obtained from the devices.

11. The apparatus of claim 10, wherein the reactors or columns with solid matter have separately conducted gas or liquid streams having substantially the same composition flow through the reactors or columns.

12. The apparatus of claim 10, wherein the central register is a central data storage device.

13. The apparatus of claim 1, wherein the reactors are multi-tube reactors.

14. The apparatus of claim 1, wherein the reactors are reaction and heat transport chambers.

15. The apparatus of claim 14, wherein the reaction and heat transport chambers are separated from one another by thermal metal sheets.

16. The apparatus of claim 10, wherein the columns are absorption columns.

17. The apparatus of claim 10, wherein the gas is an inert gas.

18. The apparatus of claim 10, wherein the solid matter is a composition comprising tower packing, catalysts, or a combination thereof.

19. The apparatus of claim 10, wherein the reactors are multi-tube reactors and the solid matter is a composition comprising catalysts.
